(19) United States
(12) Patent Application Publication
(10) Pub. No.: US 2025/0385977 A1
(43) Pub. Date: Dec. 18, 2025

(54) STORAGE MEDIUM, INFORMATION PROCESSING APPARATUS, AND SYSTEM

(71) Applicant: CANON KABUSHIKI KAISHA, Tokyo (JP)

(72) Inventor: Hikaru SUGITA, Ibaraki (JP)

(21) Appl. No.: 19/234,341

(22) Filed: Jun. 11, 2025

(30) Foreign Application Priority Data
Jun. 13, 2024 (JP) 2024-096265

(51) Int. Cl. H04N 1/00

(52) U.S. Cl. CPC H04N 1/00482; H04N 1/00244; H04N 1/00488; H04N 1/00811; H04N 1/00403

(57) ABSTRACT

This disclosure is directed to a non-transitory computer-readable storage medium storing a computer program that extends functionality of a generative AI service, the computer program causing a computer operating as an information processing apparatus to function so as to: acquire information relating to a driver for an image processing apparatus upon accepting, via the generative AI service, a scan request to read an image from a document; confirm, with a user via the generative AI service, a processing condition to be applied to the scan request based on the scan request and the acquired information relating to the driver; generate a job reflecting the confirmed processing condition; and submit the generated job to the image processing apparatus to cause the image processing apparatus to execute a scan.

### BACKGROUND

### Field of the Technology

The present disclosure relates to a storage medium, an information processing apparatus, and a system that extend functionality of an artificial intelligence system.

### Description of the Related Art

There are known artificial intelligence systems called generative AI that can generate text, images, and media of other types in response to prompts. Furthermore, there is known an AI assistance function called Microsoft 365 Copilot (registered trademark), which has a generative AI function and works in cooperation with applications such as Microsoft Excel (registered trademark) to create documents and diagrams based on natural language input. Functionality of generative AI can be extended using plugins. For example, when a sentence including the keyword “print” is input to generative AI as an instruction, a printing-related plugin is selected, and the plugin executes processing that generative AI cannot respond to on behalf of generative AI, whereby functionality can be extended.

On the other hand, among image forming apparatuses, there is known a technique of applying optical character recognition (OCR) to a scanned image to extract text appearing in the scanned document. In Japanese Patent Laid-Open No. 2024-3321, there is proposed a technique of inserting text extracted using an image forming apparatus into Microsoft Excel (registered trademark).

For example, user effort would be required in cases such as that in which a user would like to insert an image scanned using an image forming apparatus into a created document because the user would have to insert image data of the scanned image into the document after the scanned image is transmitted via a server or email. User convenience can be improved if requests for such tasks, particularly the image-processing-apparatus scanning function, can be issued to generative AI via natural language input.

### SUMMARY

The present disclosure enables realization of a mechanism for effectively using an image-processing-apparatus scanning function via generative AI.

One aspect of the present disclosure provides a non-transitory computer-readable storage medium storing a computer program that extends functionality of a generative AI service, the computer program causing a computer operating as an information processing apparatus to function so as to: acquire information relating to a driver for an image processing apparatus upon accepting, via the generative AI service, a scan request to read an image from a document; confirm, with a user via the generative AI service, a processing condition to be applied to the scan request based on the scan request and the acquired information relating to the driver; generate a job reflecting the confirmed processing condition; and submit the generated job to the image processing apparatus to cause the image processing apparatus to execute a scan.

Another aspect of the present disclosure provides an information processing apparatus that executes a computer program that extends functionality of a generative AI service, the information processing apparatus comprising: one or more memory devices that store a set of instructions; and one or more processors that execute the set of instructions to: acquire information relating to a driver for an image processing apparatus upon accepting, via the generative AI service, a scan request to read an image from a document; confirm, with a user via the generative AI service, a processing condition to be applied to the scan request based on the scan request and the acquired information relating to the driver; generate a job reflecting the confirmed processing condition; and submit the generated job to the image processing apparatus to cause the image processing apparatus to execute a scan.

Still another aspect of the present disclosure provides a system including an image processing apparatus and an information processing apparatus that provides a generative AI service to a user terminal, wherein the user terminal comprises: one or more first memory devices that store a set of instructions; and one or more first processors that execute the set of instructions to: provide the generative AI service via a screen; and accept a scan request to read an image from a document in accordance with natural language input accepted via the screen, and the information processing apparatus comprises: one or more second memory devices that store a set of instructions; and one or more second processors that execute the set of instructions to: acquire information relating to a driver for the image processing apparatus upon accepting the scan request via the generative AI service; confirm, with a user via the generative AI service, a processing condition to be applied to the scan request based on the scan request and the acquired information relating to the driver; generate a job reflecting the confirmed processing condition; and submit the generated job to the image processing apparatus to cause the image processing apparatus to execute a scan.

Further features of the present disclosure will be apparent from the following description of exemplary embodiments with reference to the attached drawings.

### BRIEF DESCRIPTION OF THE DRAWINGS

FIG. 1 is a diagram illustrating a system configuration according to one embodiment.

FIG. 2 is a diagram illustrating a configuration of an MFP according to one embodiment.

FIG. 3 is a diagram illustrating a configuration of a generative AI server according to one embodiment.

FIG. 4 is a diagram illustrating a configuration of an extension-application server according to one embodiment.

FIG. 5 is a diagram illustrating an example of a screen displayed on a user terminal according to one embodiment.

FIG. 6 is a diagram illustrating an example of screens displayed on the user terminal upon execution of scanning according to one embodiment.

FIGS. 7A-7B are a sequence diagram of scanning according to one embodiment.

FIGS. 8A-8B are a flowchart relating to the extension-application server according to one embodiment.

FIG. 9 is a diagram illustrating a system configuration according to one embodiment.

FIGS. 10A-10B are a sequence diagram of scanning according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### System Configuration

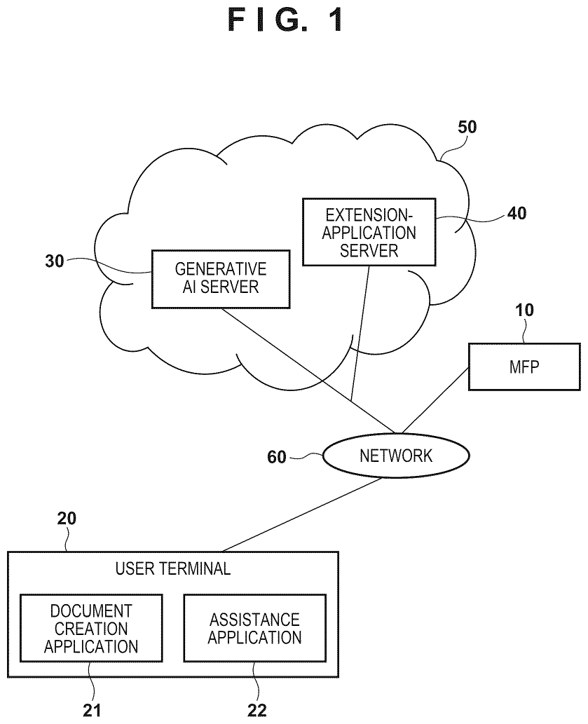

A first embodiment of the present disclosure will be described in the following. With reference to FIG. 1, an example of an overall system configuration of a scanning service according to the present embodiment will be described. The present system for providing a scanning service is configured to include: an MFP 10, which is an image processing apparatus; a user terminal 20; a generative AI server 30; and an extension-application server 40. A document creation application 21 and an assistance application 22 are installed on the user terminal 20. The apparatuses are connected via a network 60, and are capable of communicating with one another. The network 60 is a wireless or wired network formed from WAN or LAN.

The MFP 10 is an image forming apparatus that has the function of executing scanning in response to a scan instruction communicated from the extension-application server 40. The user terminal 20 is an information terminal, such as a smartphone, a tablet terminal, or a personal computer, that a user uses to create documents. The user can create documents using the document creation application 21 and the assistance application 22 installed on the user terminal 20 by operating the user terminal 20.

The document creation application 21 is a document creation application such as Microsoft Excel (registered trademark) installed on the user terminal 20. The assistance application 22 installed on the user terminal 20 is an AI assistance function that is equipped with a generative AI function and works in cooperation with the document creation application 21 to create documents and diagrams when text-based instructions are simply provided. The assistance application 22 accesses the generative AI server 30 in the cloud to execute a generative AI application.

The generative AI server 30 is a cloud server that is deployed to the cloud 50, and provides services by working in cooperation with the extension-application server 40. The generative AI server 30 interprets a message transmitted from the user terminal 20, generates an appropriate answer, and displays the answer on a screen of the user terminal 20 as a response. Furthermore, functionality of the generative AI server 30 can be extended through communication with the extension-application server 40. The extension-application server 40 is a cloud server that is deployed to the cloud 50, and provides the generative AI server 30 with additional functions. Cooperation with the extension-application server 40 makes it possible for the generative AI server 30 to execute processing that the generative AI server 30 could not execute alone.

### Configuration of Image Processing Apparatus

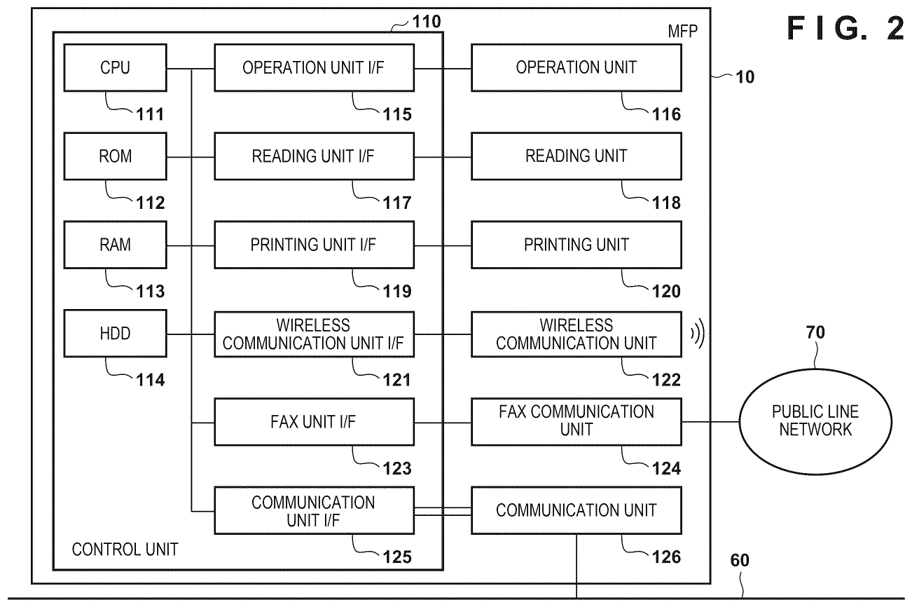

With reference to FIG. 2, an example of a hardware configuration of the MFP 10 according to the present embodiment will be described. The MFP 10 includes a control unit 110, an operation unit 116, a reading unit 118, a printing unit 120, a wireless communication unit 122, a FAX communication unit 124, and a communication unit 126. The control unit 110 includes a CPU 111, a ROM 112, a RAM 113, an HDD 114, an operation unit I/F 115, a reading unit I/F 117, a printing unit I/F 119, a wireless communication unit I/F 121, a FAX unit I/F 123, and a communication unit I/F 125.

The control unit 110 including the CPU 111 controls the operation of the entire MFP 10. The CPU 111 performs various types of control such as reading control and printing control by loading one or more control programs stored in the ROM 112 or the HDD 114 into the RAM 113. The ROM 112 stores one or more control programs that can be executed by the CPU 111. Furthermore, the ROM 112 also stores a boot program, font data, etc. The RAM 113 is the main storage memory, and is used as a work area and a temporary storage area for expanding various control programs stored in the ROM 112 and the HDD 114. The HDD 114 stores image data, print data, various types of programs, various types of addresses, and various types of setting information. The HDD 114 is a storage medium, and a solid state drive (SSD), an embedded Multi Media Card (eMMC), or the like may be applied therefor.

Note that, while one CPU 111 executes each process illustrated in a later-described flowchart using one memory (RAM 113) in the MFP 10 according to the present embodiment, there is no limitation to this. For example, each process may be executed by causing a plurality of CPUs, RAMs, ROMs, and HDDs to operate in cooperation with one another. Furthermore, a configuration may be adopted such that some processes are executed using a hardware circuit such as an ASIC or FPGA.

The operation unit I/F 115 connects the control unit 110 and the operation unit 116, which includes hardware keys and a display unit such as a touch panel, for example. The operation unit 116 functions as a user interface for displaying information to the user and detecting input from the user. The reading unit I/F 117 connects the control unit 110 and the reading unit 118, which is a scanner or the like. The reading unit 118 reads an image on a document, and the CPU 111 converts the image into image data such as binary data. The reading unit 118 performs ADF reading, in which a document is read while being conveyed, and flatbed reading, in which a document placed on a platen is read. Image data generated based on an image read by the reading unit 118 is transmitted to an external apparatus or printed onto a recording sheet. The printing unit I/F 119 connects the control unit 110 and the printing unit 120, which is a printer or the like, for example. The CPU 111 transfers image data (print data) stored in the RAM 113 to the printing unit 120 via the printing unit I/F 119. The printing unit 120 prints an image based on the transferred image data onto a sheet, such as a recording sheet, fed from a paper feed cassette.

The wireless communication unit I/F 121 is an I/F for controlling the wireless communication unit 122, and connects the control unit 110 and an external wireless apparatus, such as the user terminal 20, via wireless connection. The FAX communication unit 124 is controlled via the FAX unit I/F 123 to establish connection with a public line network 70. The FAX unit I/F 123 is an I/F for controlling the FAX communication unit 124, and, by control of a facsimile communication modem or NCU, connection to the public line network 70, control of a facsimile communication protocol, etc., can be performed. The communication unit I/F 125 connects the control unit 110 and the network 60. The communication unit I/F 125 is used to transmit image data and various types of information internal to the apparatus to an external apparatus on the network 60 and receive print data and information on the network 60 from an information processing apparatus on the network 60 via the communication unit 126. Possible methods for transmission and reception via the network 60 include transmission/reception using e-mails, and file transmission using other protocols (e.g., FTP, SMB, WEBDAV, etc.).

### Configuration of Generative AI Server

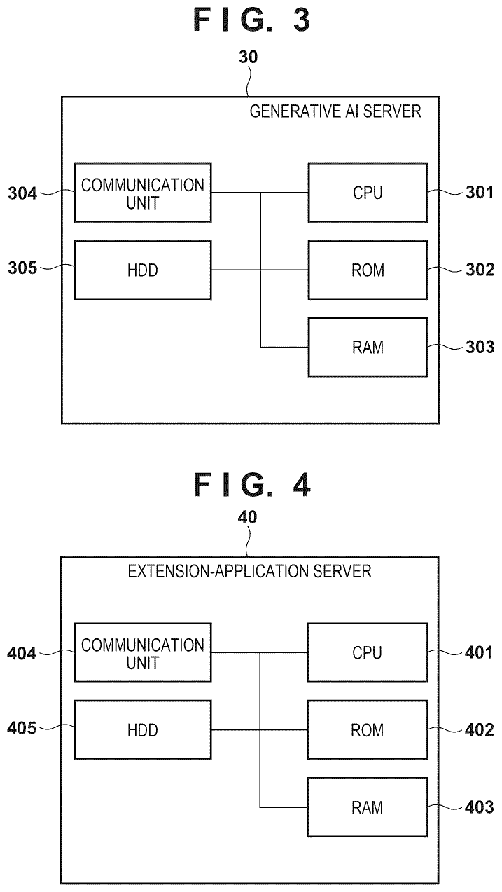

With reference to FIG. 3, an example of a hardware configuration of the generative AI server according to the present embodiment will be described. The generative AI server 30 includes a CPU 301, a ROM 302, a RAM 303, a communication unit 304, and an HDD 305.

The CPU 301 executes processing for controlling operations for generating appropriate responses by using one or more control programs stored in the ROM 302 and one or more learning models stored in the HDD 305. The ROM 302 stores one or more control programs. The RAM 303 is used as the main memory of the CPU 301 and as a temporary storage area such as a work area of the CPU 301. The HDD 305 stores various types of data, such as one or more learning models and one or more generative AI applications. The generative AI server 30 can exchange data with various types of apparatuses, such as the user terminal 20, the MFP 10, and the extension-application server 40, via the communication unit 304. Note that the communication unit 304 may perform wired communication using Ethernet (registered trademark), or may perform wireless communication such as Wi-Fi.

### Configuration of Extension-Application Server

With reference to FIG. 4, an example of a hardware configuration of the extension-application server 40 according to the present embodiment will be described. The extension-application server 40 includes a CPU 401, a ROM 402, a RAM 403, a communication unit 404, and an HDD 405.

The CPU 401 reads out one or more control programs stored in the ROM 402, and executes processing in accordance with a message received from the generative AI server 30. The ROM 402 stores one or more control programs. The RAM 403 is used as the main memory of the CPU 401 and as a temporary storage area such as a work area of the CPU 401. The HDD 405 stores the content of the message received from the generative AI server 30 or part of the message, etc. The extension-application server 40 can transmit and receive data to and from various types of apparatuses, such as the generative AI server 30, via the communication unit 404.

### Example of Screen Displayed on User Terminal

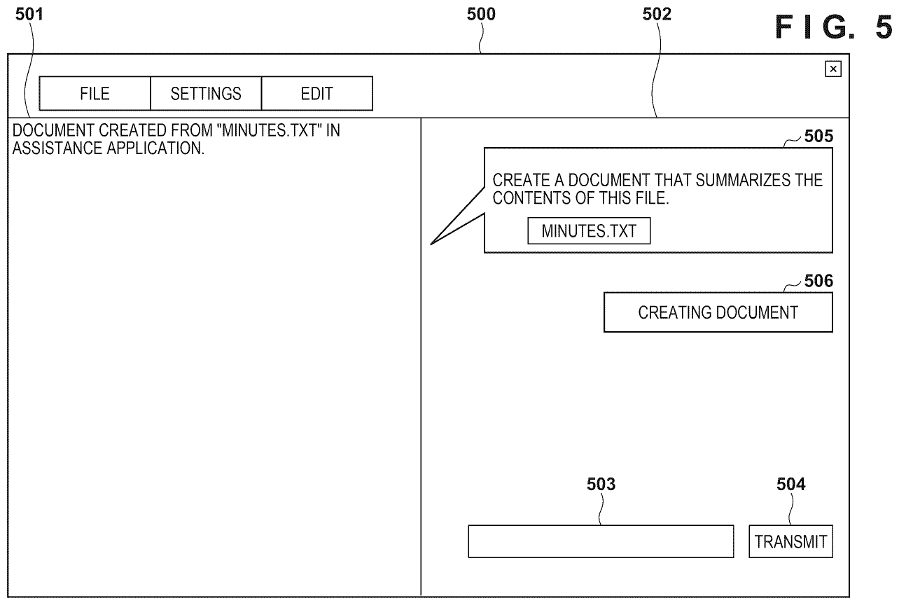

With reference to FIG. 5, an example of a screen of the document creation application 21 and the assistance application 22 that is displayed on the user terminal 20 according to the present embodiment will be described. A screen 500 is displayed on a display unit of the user terminal 20. The screen 500 is configured to include a document area 501 and an assistance application area 502.

The document area 501 is a display area relating to the document creation application 21, and is an area for creating a document. In the document area 501, an electronic document (hereinafter simply referred to as “document”) obtained by combining text input by the user, and one or more figures, tables, and/or inserted images can be created. The assistance application area 502 is a display area relating to the assistance application 22, and is an area for inputting messages to be transmitted to the generative AI server 30 and displaying responses from the generative AI server 30 displayed by the assistance application 22. Messages are added to the bottom in time series and displayed in a conversational format.

A prompt input field 503 is an example of an accepting unit, and is an input field that allows the user to input prompts to be transmitted to the generative AI server 30 via the assistance application 22. Here, an example will be described in which input is performed on the user terminal 20 in natural language text format. As a matter of course, a configuration may be adopted such that natural language input is accepted via voice input using an unillustrated microphone of the user terminal 20.

A transmit button 504 is a button that serves as a trigger for transmitting a prompt input to the prompt input field 503 to the generative AI server 30 from the assistance application 22. A prompt 505 indicates an example of a transmission history of a message input by the user. A response 506 indicates a response that has been generated by the generative AI server 30 and received by the assistance application 22.

### Example of Screens for Providing Instruction to Scan

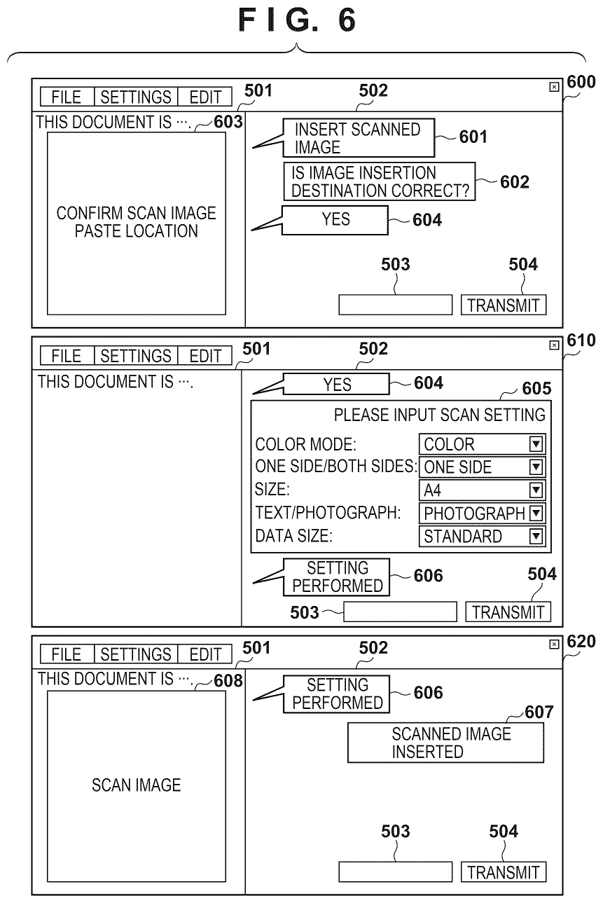

With reference to FIG. 6, an example of screens displayed on the user terminal 20 for providing an instruction to scan according to the present embodiment will be described. Screens 600, 610, and 620 are similar in configuration to the screen 500, and illustrate a display history of prompts and responses when the user provides an instruction to scan via natural language input.

As illustrated in the screen 600, a prompt 601 is an example of a prompt for providing an instruction to scan to the generative AI server 30 via the assistance application 22. Here, an instruction is provided to scan a printed material and paste the read image to a document creation file. A response 602 is a response to the prompt 601 that has been generated by the generative AI server 30 in cooperation with the extension-application server 40. The response indicates a response for confirming the insertion destination of the scanned image. Following this, interactions between the user and the assistance application 22 are displayed in chronological order in combinations of a prompt and a response.

The generative AI server 30 receives a message from the user terminal 20 via the assistance application 22, and analyzes the content thereof to return a suitable response. Furthermore, upon determining based on the content of the generated message that the message is to be processed by the extension-application server 40, the generative AI server 30 issues a processing request to the extension-application server 40. Furthermore, the generative AI server 30 creates a response to the user terminal 20 based on the content of a response from the extension-application server 40.

An image 603 in the document area 501 is an image displayed in order to instruct the position in the document creation application 21 where the scanned image will be inserted by the assistance application 22 (processing condition). A response message 604 is a message for providing a notification that the user has confirmed the size and position of the image 603. While an example of an affirmative response is illustrated here, the response may be negative. In such a manner, according to the present embodiment, a processing condition can be confirmed in a conversational format via a generative AI service. Note that a configuration may be adopted such that, if the response is negative, the insertion position can be designated by operating a predetermined position in the document area 501.

The screen 610 illustrates a state in which a response 605 that has been communicated via the generative AI server 30 and the extension-application server 40 following the response message 604 on the screen 600 is displayed. The response 605 is an example of a display object via which a setting of a processing condition, etc., can be configured, and is a response to the response message 604 that has been generated by the generative AI server 30 in cooperation with the extension-application server 40. The response is a response for designating read settings of a scan to be executed by the MFP 10.

In the response 605, the color mode, side(s) to be scanned (one or both sides), document size, document type (text, photograph, etc.), and data size for performing a scan can be configured. A dropdown button is selectably displayed in each item, and the user can configure the setting of each item by operating the dropdown button. Once the user has configured the read settings, the user provides a notification that configuration is complete via the prompt input field 503. A response message 606 is a message for providing a notification that the user has configured the reading settings in the response 605 and the settings have been confirmed.

The screen 620 illustrates a screen that is displayed following the response message 606. A response 607 indicates a response to the response message 606 that has been generated by the generative AI server 30 in cooperation with the extension-application server 40. The response 607 is a response for providing a notification that the scanned image has been inserted to the position indicated by the image 603. A scanned image 608 is inserted and displayed in the document area 501. The scanned image 608 is an image that has been read by the MFP 10 and inserted by the assistance application 22.

### Sequence

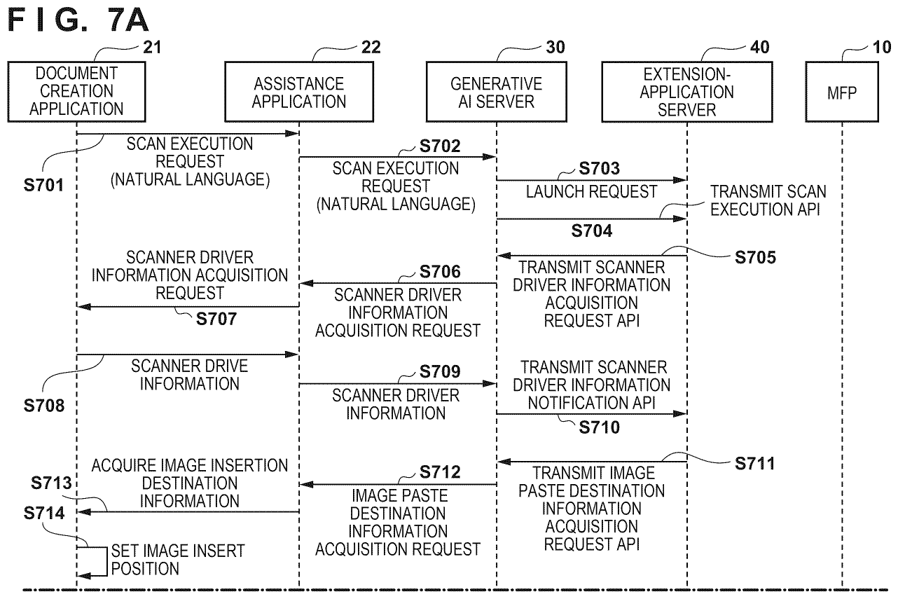

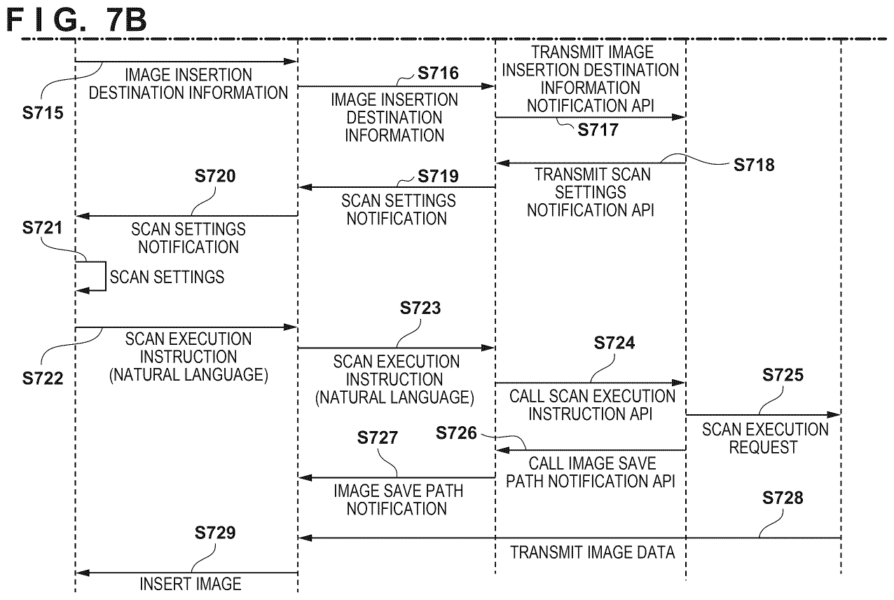

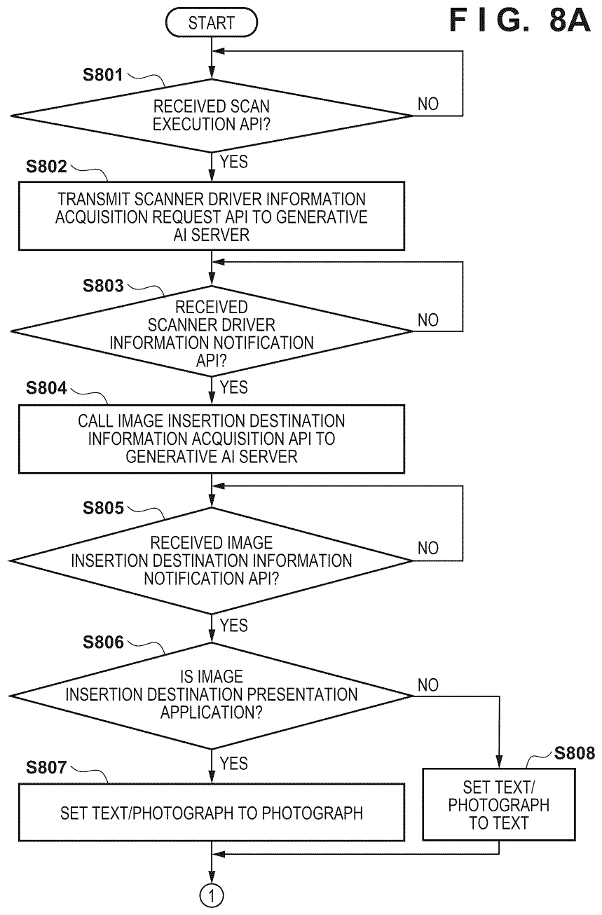

With reference to FIGS. 7A-7B, an inter-apparatus sequence for inserting a scanned image into a document in accordance with natural language input by the user according to the present embodiment will be described. In the following, the numbers following S below indicate the step numbers of individual processes.

In S701, the document creation application 21 of the user terminal 20 accepts the prompt 601, which is a request for a scan, from the user via natural language input, and transmits the accepted natural language input to the assistance application 22. Here, the prompt 601 (“insert scanned image”) is an example of a scan request issued via natural language input; however, this is not intended to limit the technique of the present disclosure, and other natural language input may be adopted. In S702, the assistance application 22 transmits the natural language that has been input in the prompt 601 to the generative AI server 30.

In S703, based on the natural language keyword “scan” received in S702, the generative AI server 30 transmits, to the extension-application server 40, a launch request to launch an extension application via which the scan can be executed. Furthermore, in S704, the generative AI server 30 transmits a scan execution API to the extension-application server 40.

In S705, the extension-application server 40 transmits a scanner driver information acquisition request API to the generative AI server 30. In S706, the generative AI server 30 transmits a scanner driver information acquisition request to the assistance application 22. In S707, the assistance application 22 transmits the scanner driver information acquisition request to the document creation application 21.

In S708, the document creation application 21 transmits scanner driver information to the assistance application 22. Here, the document creation application 21 acquires the scanner driver information from a scanner driver installed on the user terminal 20. If a plurality of scanner drivers are installed, the document creation application 21 acquires information about the scanner driver registered as the default setting, for example. The scanner driver information includes configurable items and default values, an image save path, etc.

In S709, the assistance application 22 transmits the scanner driver information received in step S708 to the generative AI server 30. In S710, the generative AI server 30 transmits a scanner driver information notification API including the information received in S709 to the extension-application server 40.

In S711, the extension-application server 40 transmits an image paste destination information acquisition request API to the generative AI server 30. In S712, the generative AI server 30 transmits, to the assistance application 22, an image insertion destination information acquisition request including content for displaying the response 602 designating the insertion destination of the scanned image and the image 603 designating the insertion destination of the scanned image. In S713, the assistance application 22 transmits the response 602 designating the insertion destination of the scanned image and the image 603 designating the insertion destination of the scanned image 603 to the document creation application 21 to have the user designate the image insertion destination.

In S714, the document creation application 21 accepts, by user input, a designation of size and position performed via the image 603. Note that, while an example is described herein in which the designation by the user is accepted via an operation on the image 603, the designation may also be accepted via natural language input. In the case of natural language input, the natural language input is not limited to only an affirmative input (“yes”) to the response 602, and may also be input for requesting correction. Note that, if the natural language input is that for requesting correction, it is desirable that the natural language input be communicated to the generative AI server 30 and the extension-application server 40, and a corrected inserted image, etc., be returned for reconfirmation with the user.

In S715, the document creation application 21 transmits image insertion destination information and the response message 604 input by the user to the assistance application 22. Here, the image insertion destination information is information including the type of the document creation application 21 (presentation application, spreadsheet application, document application, or the like), size and position information of the insertion destination (e.g., over a figure number, over a table number, or the like).

In S716, the assistance application 22 transmits the image insertion destination information received in step S715 to the generative AI server 30. In S717, the generative AI server 30 transmits, to the extension-application server 40, an API for communicating the image insertion destination information received in step S716. In S718, the extension-application server 40 transmits, to the generative AI server 30, an API for communicating scan settings including configurable items and values. In S719, the generative AI server 30 creates the scan settings response 605 from the information received in S718, and transmits, to the assistance application 22, a scan settings notification including the created information. In S720, the assistance application 22 transmits the scan settings response 605 to the document creation application 21 to have the user configure the scan settings.

In S721, the document creation application 21 accepts a user operation and modifies the settings in the scan settings response 605. The user operation is performed by directly operating various setting items displayed in the response 605. In S722, the document creation application 21 transmits the response message (natural language input) 606 input by the user to the assistance application 22. In S723, the assistance application 22 transmits, to the generative AI server 30, the response message 606 and the settings (processing conditions including setting values, etc.) configured by the user in S721. In S724, the generative AI server 30 transmits a scan execution instruction API including the setting values received in S723.

In S725, the extension-application server 40 generates a scan job reflecting the scanner driver information (including image save path) received in S710 and the setting values (processing conditions) received in S724, and submits the job by transmitting a scan execution request to the MFP 10. In S726, the extension-application server 40 transmits an image save path notification API including the image save path used in S725 to the generative AI server 30. In S727, the generative AI server 30 transmits an image save path notification to the assistance application 22.

In S728, upon completion of scan execution, the MFP 10 transmits image data to the image save path designated in S725. The assistance application 22 acquires a scanned image from the image save path received in S727. In S729, the assistance application 22 inserts the scanned image 608 into the document creation application 21, and displays the scan completion response 607.

### Processing by Extension-Application Server 40

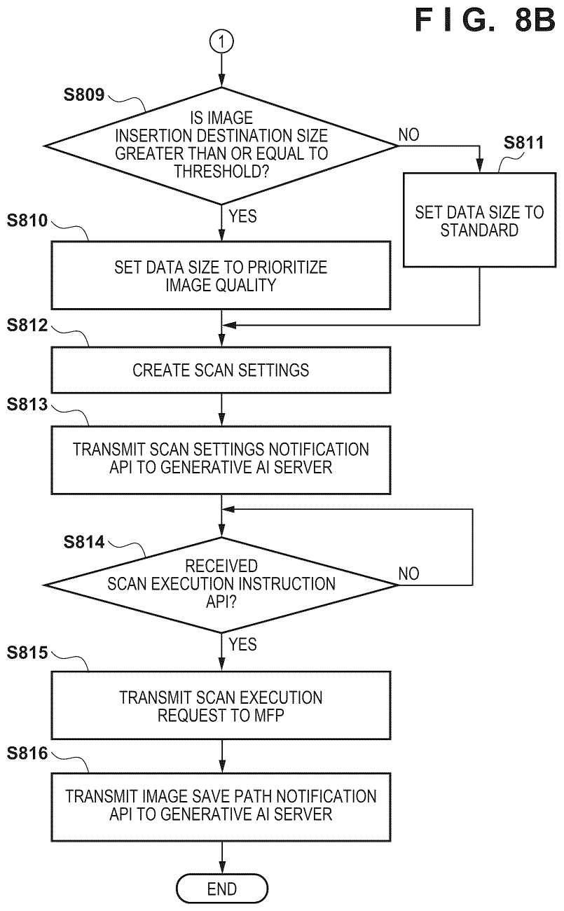

With reference to FIGS. 8A-8B, a procedure of processing by the extension-application server 40 in the present embodiment will be described. For example, the processes described in the following are realized by the CPU 401 of the extension-application server 40 loading one or more programs stored in the ROM 402 or the HDD 405 into the RAM 403 and executing the programs.

In S801, the CPU 401 determines whether or not a scan execution API has been received from the generative AI server 30. The CPU 401 transitions to S802 if a scan execution API has been received, and otherwise repeats the determination in S801. In S802, the CPU 401 transmits a scanner driver information acquisition request API to the generative AI server 30. In S803, the CPU 401 determines whether or not a scanner driver information notification API has been received from the generative AI server 30. The CPU 401 transitions to S804 if a scanner driver information notification API has been received, and otherwise repeats the determination in S803.

In S804, the CPU 401 transmits an image insertion destination information acquisition API to the generative AI server 30. In S805, the CPU 401 determines whether or not an image insertion destination information notification API has been received from the generative AI server 30. The CPU 401 transitions to S806 if an image insertion destination information notification API has been received, and otherwise repeats the determination in S805. In S806, the CPU 401 determines whether the image insertion destination is a presentation application based on the image insertion destination information received in S805. The CPU 401 transitions to S807 upon determining that the image insertion destination is a presentation application, and otherwise transitions to S808.

In S807, the CPU 401 sets a text/photograph setting among setting items in the scanner driver information received in S803 to “photograph”, and advances to S809. On the other hand, in S808, the CPU 401 sets the text/photograph setting among the setting items in the scanner driver information received in S803 to “text”, and advances to S809.

In S809, the CPU 401 determines whether or not the image insertion destination size is greater than or equal to a threshold based on the image insertion destination information received in S804. For example, the CPU 401 determines that the size is greater than or equal to the threshold if either the size in the main-scanning direction or the sub-scanning direction is greater than or equal to the preset threshold, or both the size in the main-scanning direction and the size in the sub-scanning direction are greater than or equal to the threshold. The CPU 401 transitions to S810 if the size is greater than or equal to the threshold, and otherwise transitions to S811. In S810, the CPU 401 sets a data size setting among the setting items in the scanner driver information received in S803 to “prioritize image quality”, and transitions to S812. On the other hand, in S811, the CPU 401 sets the data size setting among the setting items in the scanner driver information received in S803 to “standard”, and transitions to S812.

In S812, the CPU 401 creates scan settings obtained by combining the setting items and default values in the scanner driver information received in S803, and the items having been set in S807, S808, S810, and S811. In S813, the CPU 401 transmits a scan settings notification API including the scan settings created in S812 to the generative AI server 30. In S814, the CPU 401 determines whether or not a scan execution instruction API including setting values set by the user using the document creation application 21 has been received from the generative AI server 30. The CPU 401 transitions to S815 if a scan execution instruction API has been received, and otherwise repeats the determination in S814.

In S815, the CPU 401 generates a scan job from the scanner driver information (including an image save path) received in S803 and the setting values received in S814, and transmits a scan execution request to the MFP 10. In S816, the CPU 401 transmits an image save path notification API including the image save path designated in S815 to the generative AI server 30, and ends the processing in the present flowchart.

As described up to this point, the information processing apparatus according to the present embodiment acquires information relating to a driver for an image processing apparatus upon accepting, via a generative AI service, a scan request to read an image from a document. Furthermore, the information processing apparatus: confirms, with a user via the generative AI service, a processing condition to be applied to the scan request based on the scan request and the acquired information related to the driver; and generates a job reflecting the confirmed processing condition. The information processing apparatus submits the generated job to the image processing apparatus to cause the image processing apparatus to execute a scan. Furthermore, the processing condition to be applied to the scan request may include a setting of an item that can be configured using the driver for the image processing apparatus, and/or at least one of a position where a read image is to be inserted into an electronic document and a size of the image to be inserted. In such a manner, according to the present embodiment, an image-processing-apparatus scanning function can be used and an image can be inserted into a document creation application by a user performing natural language input on an assistance application. Thus, according to the present embodiment, a mechanism for effectively using an image-processing-apparatus scanning function via generative AI can be provided.

Note that the technique of the present disclosure is not limited to the above-described embodiment, and various configurations within the spirit and scope of the present disclosure are also included. For example, while the image save path is acquired from scanner driver information in the above-described embodiment, a modification may be adopted such that the extension-application server 40 is designated as the image save path, and image data is inserted into the document creation application 21 by being transmitted to the generative AI server 30.

### Second Embodiment

A second embodiment of the present disclosure will be described in the following. In the above-described first embodiment, scanner driver information is acquired from the document creation application 21. In the present embodiment, a configuration will be described in which scanner driver information is acquired from a cloud scan server.

### System Configuration

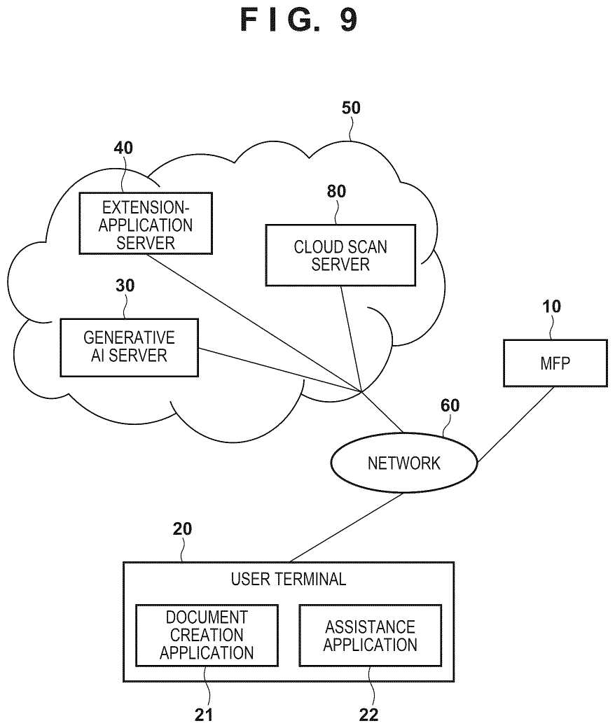

With reference to FIG. 9, an example of an overall system configuration of a scanning service according to the present embodiment will be described. Here, description will be provided only of configurations differing from those in the above-described first embodiment.

A system according to the present embodiment further includes a cloud scan server 80 in the cloud 50 as a cloud server, in addition to the configurations illustrated in FIG. 1. The cloud scan server 80 manages information about image processing apparatuses in association with cloud scan IDs. Accordingly, by communicating a cloud scan ID to the cloud scan server 80, information about the corresponding image processing apparatus, e.g., information relating to a driver for the image processing apparatus, can be acquired. Note that, while an example in which various servers are provided separately is described herein, the servers may be provided integrally with other servers. For example, the generative AI server 30, the extension-application server 40, and the cloud scan server 80 may be provided integrally.

### Sequence

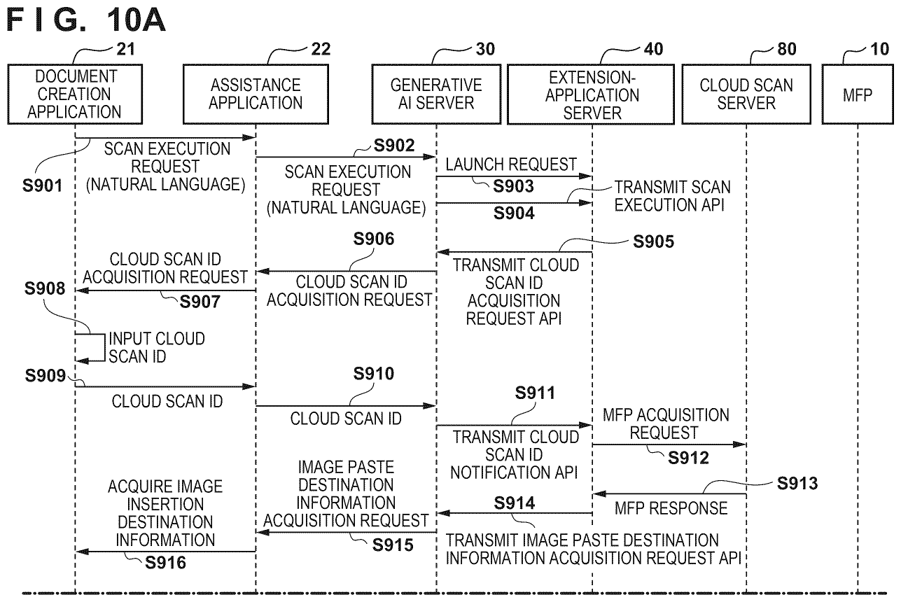

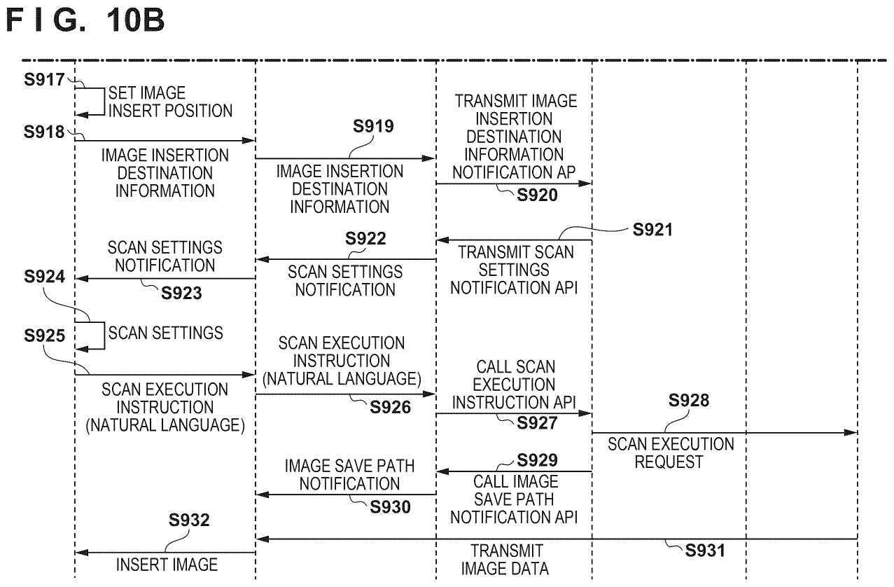

With reference to FIGS. 10A-10B, an inter-apparatus sequence for inserting a scanned image into a document in accordance with natural language input by the user according to the present embodiment will be described. Note that description regarding the operations in S901 to S904 (corresponding to S701 to S704) and S914 to S932 (corresponding to S711 to S729), which are similar to those in the above-described first embodiment, is omitted.

In S905, the extension-application server 40 transmits a cloud scan ID acquisition request API to the generative AI server 30. In S906, the generative AI server 30 generates a cloud scan ID acquisition response, and transmits, to the assistance application 22, a cloud scan ID acquisition request including the cloud scan ID acquisition response. In S907, the assistance application 22 transmits the cloud scan ID acquisition request received in S906 to the document creation application 21 to have the user input a cloud scan ID.

In S908, the document creation application 21 accepts user input of a cloud scan ID. Here, by inputting the cloud scan ID associated with the image processing apparatus that the user is using, the user can execute a job using the scanning function on the image processing apparatus. Note that there may also be cases in which the user does not designate a cloud scan ID, in which case the cloud scan ID set by default is used. For example, the default cloud scan ID may be selected and set based on a group associated with a user ID, etc. In S909, the document creation application 21 transmits a response message including the accepted cloud scan ID to the assistance application 22. In S910, the assistance application 22 transmits the response message received in step S909 to the generative AI server 30. In S911, the generative AI server 30 transmits, to the extension-application server 40, an API for communicating the cloud scan ID received in S910.

In S912, the extension-application server 40 transmits, to the cloud scan server 80, an MFP acquisition request for acquiring MFP information registered to the cloud scan ID received in S911. In S913, the cloud scan server 80 transmits an MFP response (including information relating to a driver for the image processing apparatus) to the extension-application server 40. The processes in and following S914 are the same as those in the sequence illustrated in FIGS. 7A-7B, and description thereof is thus omitted.

As described up to this point, the information processing apparatus according to the present embodiment acquires, from a cloud server, the information relating to the driver for the image processing apparatus, the driver running on a user terminal operated by the user. Scanning using the image forming apparatus can be performed and an image can be inserted into the document creation application by acquiring the scanner driver information from the cloud scan server.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-096265, filed Jun. 13, 2024, which is hereby incorporated by reference herein in its entirety.

What is claimed is:

1. A non-transitory computer-readable storage medium storing a computer program that extends functionality of a generative AI service, the computer program causing a computer operating as an information processing apparatus to function so as to:
acquire information relating to a driver for an image processing apparatus upon accepting, via the generative AI service, a scan request to read an image from a document;
confirm, with a user via the generative AI service, a processing condition to be applied to the scan request based on the scan request and the acquired information relating to the driver;
generate a job reflecting the confirmed processing condition; and
submit the generated job to the image processing apparatus to cause the image processing apparatus to execute a scan.

2. The non-transitory computer-readable storage medium according to claim 1,
wherein the processing condition to be applied to the scan request includes a setting of an item that can be configured using the driver for the image processing apparatus.

3. The non-transitory computer-readable storage medium according to claim 2,
wherein the processing condition to be applied to the scan request includes at least one of a position where a read image is to be inserted into an electronic document and a size of the image to be inserted.

4. The non-transitory computer-readable storage medium according to claim 3,
wherein the computer program causes the computer operating as the information processing apparatus to further function so as to confirm the processing condition to be applied to the scan request with the user in a conversational format via the generative AI service.

5. The non-transitory computer-readable storage medium according to claim 4,
wherein the computer program causes the computer operating as the information processing apparatus to further function so as to acquire the processing condition to be applied to the scan request based on natural language input by the user that is input via the generative AI service.

6. The non-transitory computer-readable storage medium according to claim 4,
wherein the computer program causes the computer operating as the information processing apparatus to further function so as to provide a user terminal of the user with a display object via which the processing condition to be applied to the scan request can be configured, and acquire a setting configured via the display object.

7. The non-transitory computer-readable storage medium according to claim 4,
wherein the computer program causes the computer operating as the information processing apparatus to further function so as to provide a user terminal of the user with an image representing the electronic document and acquire at least one of the position and the size designated via the provided image.

8. The non-transitory computer-readable storage medium according to claim 1,
wherein the computer program causes the computer operating as the information processing apparatus to further function so as to acquire, via a generative AI server that provides the generative AI service, the information relating to the driver for the image processing apparatus, the driver running on a user terminal of the user.

9. The non-transitory computer-readable storage medium according to claim 1,
wherein the computer program causes the computer operating as the information processing apparatus to further function so as to acquire, from a cloud server, the information relating to the driver for the image processing apparatus, the driver running on a user terminal of the user.

10. An information processing apparatus that executes a computer program that extends functionality of a generative AI service, the information processing apparatus comprising:
one or more memory devices that store a set of instructions; and
one or more processors that execute the set of instructions to:
acquire information relating to a driver for an image processing apparatus upon accepting, via the generative AI service, a scan request to read an image from a document;
confirm, with a user via the generative AI service, a processing condition to be applied to the scan request based on the scan request and the acquired information relating to the driver;
generate a job reflecting the confirmed processing condition; and
submit the generated job to the image processing apparatus to cause the image processing apparatus to execute a scan.

11. A system including an image processing apparatus and an information processing apparatus that provides a generative AI service to a user terminal,
wherein the user terminal comprises:
one or more first memory devices that store a set of instructions; and
one or more first processors that execute the set of instructions to:
provide the generative AI service via a screen; and
accept a scan request to read an image from a document in accordance with natural language input accepted via the screen, and
the information processing apparatus comprises:
one or more second memory devices that store a set of instructions; and
one or more second processors that execute the set of instructions to:
acquire information relating to a driver for the image processing apparatus upon accepting the scan request via the generative AI service;
confirm, with a user via the generative AI service, a processing condition to be applied to the scan request based on the scan request and the acquired information relating to the driver;
generate a job reflecting the confirmed processing condition; and
submit the generated job to the image processing apparatus to cause the image processing apparatus to execute a scan.
